(19) United States
(12) Patent Application Publication
(10) Pub. No.: US 2025/0030967 A1
(43) Pub. Date: Jan. 23, 2025

(54) DISTRIBUTED MULTI-ANTENNA COLLABORATIVE PHASE STABILIZATION METHOD AND APPARATUS FOR FUTURE BROADBAND WIRELESS COMMUNICATION

(71) Applicant: Zhejiang University, Hangzhou (CN)

(72) Inventors: Xiaofeng JIN, Hangzhou (CN); Jijun ZOU, Hangzhou (CN); Ling YANG, Hangzhou (CN); Zhiwei LI, Hangzhou (CN); Yafeng ZHU, Hangzhou (CN); Bing WEI, Hangzhou (CN)

(21) Appl. No.: 18/357,083

(22) Filed: Jul. 21, 2023

(51) Int. Cl. H04Q 11/00

(52) U.S. Cl. CPC H04Q 11/0071; H04Q 11/0005; H04Q 2011/0016; H04Q 2011/0026; H04Q 2011/0083

(57) ABSTRACT

A distributed multi-antenna collaborative phase stabilization device for future broadband wireless communication. The device includes a central station and various antenna terminals interconnected via optical fibers to form a linear communication system. The distributed multi-antenna reception signals are optically modulated at the antenna terminals into different wavelengths of optical signals, and then coupled into a single optical fiber using wavelength division multiplexing technology for transmission to the central station. At the central station, the optical signals are converted back into the original RF (radio frequency) signals through optoelectronic conversion.

### FIELD OF THE DISCLOSURE

The present disclosure relates to the field of microwave photonics technology, especially to a distributed multi-antenna collaborative phase stabilization method and apparatus for future broadband wireless communication.

### BACKGROUND OF THE DISCLOSURE

The method of utilizing distributed multi-antenna for high-frequency carrier transmission and reception in future broadband wireless communication involves deploying antenna arrays across an extensive area. The collaboration among multiple antennas becomes a critical consideration in this system, necessitating frequency synchronization between antennas. As the communication frequency of such systems increases, there arises a greater demand for signal stability. Additionally, traditional radio frequency transmission encounters severe signal attenuation when distances extend significantly, presenting challenges for the transmission of collaborative signals across a broad area.

In contrast, optical fiber communication has been widely employed for long-distance data exchange due to its advantages of large bandwidth, low attenuation, interference resistance, and enhanced security. The global network of optical fiber addresses the limitations of traditional microwave technology, which experiences high losses, limited available bandwidth resources, and inadequate security. However, optical fiber is not entirely stable in its environment and can experience random delays caused by mechanical stress and temperature changes. These delays introduce phase drift and jitter during signal propagation, which impacts system performance. Therefore, the objective of optical fiber phase stabilization technology is to suppress the delays or ensure phase stability in transmitting radio frequency signals through optical fibers. The importance of optical fiber phase stabilization technology is evident in radar communication, deep space exploration, radar positioning, and other multi-base, distributed multi-antenna collaborative systems. In the future, with the anticipated rates of broadband wireless communication systems exceeding tenfold of current rates, the synchronization systems will face even higher demands. If the long-distance optical fiber channels are not stabilized, signals will be affected by fluctuations in optical fiber delay during forward and backward reception, leading to significant clock recovery computations at the receiving end and potentially causing network congestion. Thus, future high-speed mobile communication systems require advanced phase stabilization transmission technology.

With the rapid development of microwave photonics, various methods have been provided for the stable transmission and centralized processing of distributed multi-antenna collaborative signals. In optical fiber phase stabilization transmission, delay compensation can be achieved through active and passive methods. Active compensation utilizes phase retrieval techniques to measure the delay variation of optical fibers in their environment. Subsequently, active compensation devices are employed to compensate for the delay or signal phase, mitigating the effects of the optical fiber. Adjustable laser diodes, temperature-controlled fiber delay lines, and other means can be used for delay compensation. However, these methods often have limited compensation ranges and lower loop bandwidths, making them unable to compensate for phase jitter above a certain frequency. Nevertheless, they enable stable transmission of multiple reference signals or ensure the operation of broadband digital communication. On the other hand, passive compensation methods, theoretically using mixers, offer faster compensation speeds but share similar drawbacks as active compensation methods.

### SUMMARY OF THE DISCLOSURE

Considering the aforementioned points, the present disclosure proposes a method and apparatus for distributed multi-antenna collaborative phase stabilization, tailored for future broadband wireless communication. This system comprises a central station and multiple antenna terminals. It employs delay jitter measurement and phase compensation to achieve optical fiber phase stabilization for distributed multi-antenna collaborative signals. This approach effectively resolves the challenges of decentralized processing of signals from distributed multi-antenna systems in space, thereby conserving the construction and operational costs associated with such systems.

The central station receives data signals from the antenna terminals, demodulates the data signals, and utilizes an optoelectronic conversion module (O/E) to obtain the original radio frequency (RF) signals. When phase stabilization is required, the central station sequentially sends jitter measurement signals to each antenna terminal to measure the link's delay jitter and calculate the compensation amount for delay jitter. Finally, the central station broadcasts the control signal to the antenna terminals, and the antenna terminals perform the link phase stabilization operation accordingly.

The antenna terminal modulates the RF signals received from the distributed multi-antenna system using an optoelectronic modulation module (E/O) to different wavelengths of optical carriers. Each antenna terminal employs wavelength division multiplexing to couple the optical signals of different wavelengths onto a single optical fiber for transmission to the central station. During delay jitter measurement, the antenna terminal reflects the jitter measurement signal back to the central station as feedback, enabling the completion of delay jitter measurement for the optical link between the central station and antenna terminal i. Antenna terminal i receives the control signal from the central station and performs optical fiber phase compensation between the central station and antenna terminal i.

Furthermore, the central station comprises a delay jitter measurement module, a first optoelectronic modulation circuit, a first wavelength division multiplexer, a first photodetector, a central station microcontroller, a direct modulation laser, and an optoelectronic conversion module. The delay jitter measurement module generates delay jitter measurement signals, which are converted into optical signals by the first optoelectronic modulation circuit and transmitted to the antenna terminal. The feedback signal received from the antenna terminal is converted into an electrical signal by the first photodetector and processed in the delay jitter measurement module to obtain a phase signal related to the optical link delay.

The central station microcontroller calculates the delay compensation amount for the optical delay line based on the phase signal and sends the control signal to perform the optical fiber phase compensation.

The direct modulation laser is utilized to modulate the control instructions from the microcontroller onto the optical carrier with a wavelength of λ. The control signal is then broadcasted to all antenna terminals.

The first wavelength division multiplexer couples different wavelength optical signals into the same optical fiber link for transmission.

The optoelectronic conversion module converts the demultiplexed optical signals, received through the first wavelength division multiplexer, into electrical signals.

Furthermore, the antenna terminal comprises an optical delay line, a second optoelectronic modulation circuit, an optoelectronic switch, a second wavelength division multiplexer, a third wavelength division multiplexer, a splitter, an optical filter, a second photodetector, an antenna terminal microcontroller, and a Faraday rotating mirror.

The second optoelectronic modulation circuit modulates the collaborative signals from multiple antennas onto optical carriers with different wavelengths. These different wavelength optical signals are coupled into a single optical fiber and transmitted back to the central station through the second wavelength division multiplexer.

The optoelectronic switch, based on instructions from the antenna terminal microcontroller, determines whether the jitter measurement signal is coupled back to subsequent antenna terminals through the third wavelength division multiplexer or reflected back to the central station through the Faraday rotating mirror, completing the delay jitter measurement for the optical fiber link between the central station and this particular antenna terminal.

The optical delay line can be controlled and adjusted by the antenna terminal microcontroller to change the delay of the optical signal. This capability allows for compensating the delay variations in the link, thereby stabilizing the phase of the transmitted optical signal.

The optical splitter extracts 1% of the light from the main optical fiber for the extraction of control signals.

The antenna terminal microcontroller is responsible for receiving the control signals sent from the central station. It manages the switching of the optoelectronic switch and controls the operation of the optical delay line in the antenna terminal.

Furthermore, the delay jitter measurement module generates the jitter measurement signal RF, which is sequentially transmitted to each antenna terminal i. After being demultiplexed through the second wavelength division multiplexer, the delay jitter measurement signal is reflected back to the central station via the Faraday rotating mirror. The reflected signal RF′ is then obtained by photodetection using the first photodetector. By comparing the phase difference between RF and RF′ within the module, the delay variation information of the optical fiber link between the central station and antenna terminal i is extracted as a phase signal.

This phase signal is forwarded to the central station microcontroller, which calculates the delay compensation amount based on this information.

Furthermore, the system employs wavelength division multiplexing to transmit the uplink data signals and the downlink jitter measurement and control signals through the same optical fiber, forming a linear communication system. The jitter measurement signal at each antenna terminal is initially separated from the main optical path by the second wavelength division multiplexer. Then, through the optoelectronic switch, it is determined whether the jitter measurement signal is reflected back to the central station via the Faraday rotating mirror to complete the delay jitter measurement for the optical fiber link between the central station and that particular antenna terminal, or if it is coupled back to the main optical path via the third wavelength division multiplexer to continue transmission to subsequent antenna terminals. This system's delay jitter measurement process does not interfere with the transmission of uplink data signals.

The process of the system stabilization operation includes: subsequently transmitting, by the central station, a delay jitter measurement command to each of the antenna terminals i; activating, by the corresponding antenna terminal i, the optoelectronic switch to direct the path of the Faraday rotating mirror, allowing the jitter measurement signal to be reflected back to the jitter measurement module of the central station to obtain the phase signal; calculating, by the central station single-chip microcontroller, the delay compensation value based on the phase signal, and transmitting the control command to the corresponding antenna terminal i; receiving, by the corresponding antenna terminal i; the control command and drive the optical delay line to compensate the delay jitter of the fiber link between the central station and the antenna terminal i; since the delay jitter in the fiber link between the central station and antenna terminal i−1 has been compensated by antenna terminal i−1, the compensation performed by antenna terminal i is equivalent to compensating for the delay jitter in the segment of the optical fiber between the antenna terminal i−1 and the antenna terminal i.

### BRIEF DESCRIPTION OF DRAWINGS

FIG. 1 is a system block diagram showing the device according to the present disclosure.

FIG. 2 is a schematic diagram showing the central station and the antenna terminals.

Character references: 1—First laser; 2—first Mach-Zehnder Modulator; 3—First wavelength division multiplexer; 4—delay jitter measurement module; 5—First photodetector; 6—Central station single-chip microcontroller; 7—Direct modulation laser; 8—Optoelectrnoic conversion module; 9—Single-mode optical fiber; 10—Optical delay line; 11—Second wavelength division multiplexer; 12—Third wavelength division multiplexer; 13—Fraday mirror; 14—Optical splitter; 15—Optical filter; 16—Second photodetector; 17—Antenna terminal single-chip microcontroller; 18—Optoelectronic switch; 19—Third laser; 20—Third Mach-Zehnder modulator.

### DETAILED DESCRIPTION OF THE DISCLOSURE

In order to describe the present disclosure more specifically, the technical solutions of the present disclosure will be described in detail below in conjunction with the accompanying drawings and specific embodiments.

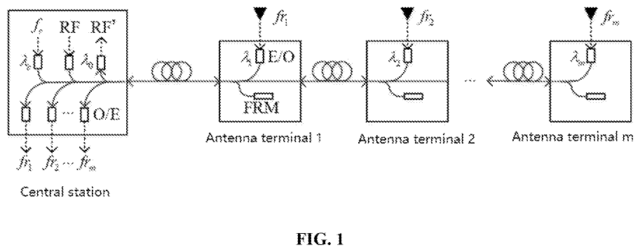

As shown in FIG. 1, the present disclosure is a distributed multi-antenna collaborative phase stabilization device for future broadband wireless communication. The system comprises a central station and m antenna terminals, interconnected via single-mode optical fibers to form a linear communication structure. Each antenna terminal i modulates the RF (radio frequency) signals received from the distributed multi-antenna system using an optoelectronic modulation module (E/O), specifically the second optoelectronic modulation circuit, which comprises a third laser and a third Mach-Zehnder Modulator. The RF signals are modulated onto optical carriers with different wavelengths. The antenna terminals employ wavelength division multiplexing to couple the optical signals of different wavelengths into a single optical fiber for transmission to the central station. At the central station, the signals are demultiplexed, and then converted back into RF signals through an optoelectronic conversion module (O/E), denoted as optoelectronic conversion module 8, for subsequent processing. The system is designed such that the central station is responsible for delay jitter measurement, while the antenna terminals are responsible for compensating the optical fiber delay jitter.

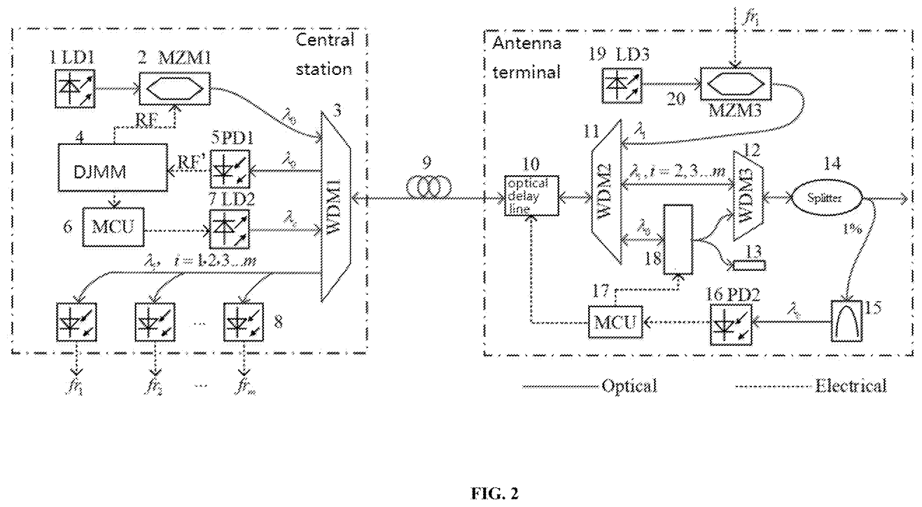

As shown in FIG. 2, it illustrates the structure of the central station and antenna terminal for the device of the present disclosure. The central station includes a first laser (LD) 1, a second Mach-Zehnder modulator (MZM) 2, a first wavelength division multiplexer (WDM) 3, a delay jitter measurement module (DJMM) 4, a first photodetector (PD) 5, a central station single-chip microcontroller (MCU) 6, a direct modulation laser 7, an optoelectronic conversion module 8. The antenna terminal includes a second wavelength division multiplexer 11, a third wavelength division multiplexer 12, a Faraday rotating mirror (FRM) 13, an optical splitter 14, an optical filter 15, a second photodetector 16, an antenna terminal single-chip microcontroller 17, an optoelectronic switch 18, a third laser 19, a third Mach-Zehnder modulator 20.

When antenna terminal i requires phase stabilization, the central station broadcasts the address of antenna terminal i to all antenna terminals through the control optical path with a wavelength of λ. The control signal reaches each antenna terminal through the optical splitter 14. Each antenna terminal filters out the control signal corresponding to the wavelength λ using the optical filter 15 and converts it into an electrical signal using the second photodetector 16. Upon receiving the address information sent by the central station, antenna terminal i activates the optoelectronic switch 18 to select the corresponding reflected optical path using the Faraday rotating mirror 13. Meanwhile, the first optoelectronic modulation circuit, including first laser and First Mach-Zehnder Modulator, modulates the jitter measurement signal RF (radio frequency) onto the optical carrier with a wavelength of λ. The modulated RF signal is coupled into the main optical fiber through the first wavelength division multiplexer (WDM) 1 and transmitted to the antenna terminal. The jitter measurement signal RF′ is obtained at the central station by reflecting the jitter measurement signal RF through the Faraday rotating mirror back to the central station. The RF′ signal carries information about the delay variation in the optical fiber link between the central station and antenna terminal i. RF′ is converted into an electrical signal by the first photodetector (PD) 5 and combined with RF at the delay jitter measurement module 4 to generate a phase signal. The central station microcontroller (MCU) 6 calculates the delay jitter value of the link based on the phase signal and sends a control command to antenna terminal i. Antenna terminal i receives the control command and controls the optical delay line 10 to compensate for the delay jitter in the optical fiber link between the central station and antenna terminal i. As the delay jitter in the optical fiber link between the central station and antenna terminal i−1 has already been compensated by antenna terminal i−1, the compensation performed by antenna terminal i is equivalent to compensating for the delay jitter in the segment of the optical fiber between antenna terminal i−1 and antenna terminal i.

Let's assume the initial phase of RF signal is φ₀; τ_{comp,forward}, and τ_{comp,backward} are the compensation made by the active compensation device for the delay when the signals are transmitted forward or backward; τ_{drift,forward}, and τ_{drift,backward} are the delay changes on the fiber link when the signals are transmitted forward or backward; τ_{link,forward}, and τ_{link,backward} are the initial delay when the signals are transmitted forward or backward.

The expressions for the time variation τ_{drift} of the optical fiber link delay and the round-trip time τ_{round} of the measurement signal is as follows:

$${τ}_{round} ≪ {τ}_{drift} \qquad ( 1 )$$

Then we can obtain the following expression:

$${τ}_{comp , forward} = {τ}_{comp , backward} = {τ}_{comp} \qquad ( 2 )$$

The forward transmission delay changes are identical to the backward transmission delay changes. The delay of initial forward and backward transmissions are identical. f_{RF} is the frequency of RF signal, and the comparison by the central station is as follows:

$$Δφ = 2 \cdot {f}_{RF} \cdot ( {τ}_{link} + {τ}_{comp} + {τ}_{drift} ) \qquad ( 3 )$$

Assuming the initial phase as:

$${φ}_{init} = 2 \cdot {f}_{RF} \cdot {τ}_{link} \qquad ( 4 )$$

Compare the initial phase with the phase signal outputted by the phase discriminator, the delay jitter is measured, and subsequently the optical delay line is driven to compensate change delay according to the measurement results, so that τ_{comp}=τ_{drift}, and

$$Δφ ≡ 2 \cdot {f}_{RF} \cdot {τ}_{link} ≡ {φ}_{init} \qquad ( 5 )$$

For the central station, the received signal and the delay jitter measurement signal pass through the same link, so they experience the same delay. The phase variation for the central station is thus:

$${Δφ}_{trans} = Δφ \cdot \frac{{f}_{trans}}{{f}_{RF}} \qquad ( 6 )$$

Accordingly, with this active compensation, the link delay is compensated, achieving phase stabilization for the collaborative multi-antenna signal transmission from the antenna terminal to the central station.

Under the premise of phase stabilization, the collaborative multi-antenna signal undergoes optoelectronic modulation by the third laser (LD) 3 and Third Mach-Zehnder, modulator (MZM) 3 with a wavelength of λ, resulting in an optical signal. The optical signal is then coupled into the signal transmission link through the second wavelength division multiplexer (WDM) 2 and transmitted over single-mode optical fiber to the central station. At the central station, the signal is demultiplexed using the first wavelength division multiplexer (WDM) 1 and converted back into the original multi-antenna signal through the optoelectronic conversion module 8. When the antenna terminal does not require phase stabilization, the optoelectronic switch 18 selects the alternative optical path. The jitter measurement signal passes through the third wavelength division multiplexer (WDM) 3 and couples into the main optical fiber, continuing to reach subsequent antenna terminals.

The present disclosure discloses a distributed multi-antenna collaborative phase stabilization method and device for future broadband wireless communication. The device includes a central station and various antenna terminals interconnected via optical fibers to form a linear communication system. The distributed multi-antenna reception signals are optically modulated at the antenna terminals into different wavelengths of optical signals, and then coupled into a single optical fiber using wavelength division multiplexing (WDM) technology for transmission to the central station. At the central station, the optical signals are converted back into the original RF signals through optoelectronic conversion. The system at the central station utilizes delay jitter measurement to obtain the variation in link delay and subsequently sends control signals to the antenna terminals to compensate for the delay jitter using the optical delay lines. This device facilitates the stable transmission of collaborative multi-antenna signals in wireless communication systems, enabling centralized and unified processing of multi-antenna signals, while also saving on the construction and operational costs of the distributed multi-antenna system. The structure of this disclosure is simple, easy to implement, and can be easily expanded and scaled.

The above description of the embodiments is for those of ordinary skill in the art to understand and apply the present disclosure. It is apparently that those skilled in the art may make various modifications to the aforementioned embodiments, and apply the general principles described here to other embodiments without creative efforts. Therefore, the present disclosure is not limited to the above embodiments, and improvements and modifications made by those skilled in the art according to this disclosure should fall within the protection scope of the present disclosure.

What is claimed is:

1. A distributed multi-antenna collaborative phase stabilization device for future broadband wireless communication, comprising a plurality of antenna terminals and a central station; the central station and each of the plurality of antenna terminals are interconnected through an optical fiber;
the central station is configured to receive optical signals uploaded by the antenna terminals and demultiplex the optical signals through wavelength division multiplexing to obtain original received signals frᵢ; the central station is configured to sequentially send jitter measurement signals to each antenna terminal for delay jitter measurement and obtain delay compensation values, and then to broadcast a control command to the antenna terminals to complete a phase stabilization operation;
the antenna terminals are configured to modulate the original received signals frᵢ into optical carriers λᵢ with different wavelengths through optoelectronic modulation; the optical signals from the plurality of antenna terminals are coupled into the optical fiber through wavelength division multiplexing and transmitted to the central station; the antenna terminal i is capable of reflecting the jitter measurement signal back to the central station to complete the delay jitter measurement between the central station and antenna terminal i; the antenna terminal i is capable of receiving the control command from the central station to perform delay compensation for the optical fiber between the central station and antenna terminal i.

2. The device according to claim 1, wherein the central station comprises a delay jitter measurement module, a first optoelectronic modulation circuit, a first wavelength division multiplexer, a first photodetector, a central station single-chip microcontroller, a direct modulation laser, an optoelectronic conversion module; wherein the delay jitter measurement module is configured to generate delay jitter measurement signals, which are converted into optical signals by the first optoelectronic modulation circuit and transmitted to the antenna terminals; feedback signals from the antenna terminals is converted into electrical signals by the first photodetector and used in the delay jitter measurement module to obtain phase signals associated with optical fiber link delay;
the central station single-chip microcontroller is configured to calculate the delay compensation value for optical delay line based on the phase signals and send the control command;
the direct modulation laser is configured to modulate the control command of the central station single-chip microcontroller into the optical carriers with a wavelength of λ_{c}; the control command is broadcasted to each of the antenna terminals;
the first wavelength division multiplexer is configured to couple optical signals with different wavelength into the same optical fiber link for transmission;
the optoelectronic conversion module is configured to convert the optical signals demultiplexed by the first wavelength division multiplexer into electrical signals.

3. The device according to claim 1, wherein the antenna terminal comprises an optical delay line, a second optoelectronic modulation circuit, an optoelectronic switch, a second wavelength division multiplexer, a third wavelength division multiplexer, an optical splitter, an optical filter, a second photodetector, an antenna terminal single-chip microcontroller, a Faraday rotating mirror;
wherein the second optoelectronic modulation circuit is configured to modulate collaborative signals onto the optical carriers with different wavelengths; the optical signals with different wavelengths are coupled into the optical fiber and transmitted back to the central station through the second wavelength division multiplexer;
the optoelectronic switch is configured to, based on commands from the antenna terminal single-chip microcontroller, to determine whether the jitter measurement signal is coupled back to subsequent antenna terminals through the third wavelength division multiplexer or reflected back to the central station through the Faraday rotating mirror for completing the delay jitter measurement for the optical fiber link between the central station and the antenna terminal;
the optical delay line is capable of being controlled and adjusted by the antenna terminal single-chip microcontroller to change the delay of the optical signal, allowing for compensating the delay variations in the link, thereby stabilizing the phase of the transmitted optical signal;
the optical splitter is configured to extract 1% of light from the optical fiber for extraction of the control command;
the antenna terminal single-chip microcontroller is configured for receiving the control command sent from the central station, managing the switching of the optoelectronic switch and controlling the operation of the optical delay line in the antenna terminal.

4. The device according to claim 2, wherein the delay jitter measurement module is configured to generate the jitter measurement signal RF, which is sequentially transmitted to each antenna terminal i; after being demultiplexed through the second wavelength division multiplexer, the delay jitter measurement signal is reflected back to the central station via the Faraday rotating mirror; signal RF′ is then obtained by photodetection using the first photodetector; by comparing the phase difference between RF and RF′ within the module, the phase signal of the delay variation information of the optical fiber link between the central station and antenna terminal i is extracted; the phase signal is forwarded to the central station single-chip microcontroller, which calculates the delay compensation value based on the phase signal.

5. The device according to claim 1, wherein the system employs wavelength division multiplexing to transmit the uplink data signals and the downlink jitter measurement and control signals through the same optical fiber, forming a linear communication system; the jitter measurement signal at each antenna terminal is initially separated from the main optical path by the second wavelength division multiplexer; then, through the optoelectronic switch, the jitter measurement signal is determined to be reflected back to the central station via the Faraday rotating mirror to complete the delay jitter measurement for the optical fiber link between the central station and that antenna terminal, or to be coupled back to the main optical path via the third wavelength division multiplexer to continue transmission to subsequent antenna terminals.

6. The device according to claim 1, wherein a process of the system stabilization operation comprises:
subsequently transmitting, by the central station, a delay jitter measurement command to each of the antenna terminals i;
activating, by the corresponding antenna terminal i, the optoelectronic switch to direct the path of the Faraday rotating mirror, allowing the jitter measurement signal to be reflected back to the jitter measurement module of the central station to obtain the phase signal;
calculating, by the central station single-chip microcontroller, the delay compensation value based on the phase signal, and transmitting the control command to the corresponding antenna terminal i;
receiving, by the corresponding antenna terminal i; the control command and drive the optical delay line to compensate the delay jitter of the fiber link between the central station and the antenna terminal i; since the delay jitter in the fiber link between the central station and antenna terminal i−1 has been compensated by antenna terminal i−1, the compensation performed by antenna terminal i is equivalent to compensating for the delay jitter in the segment of the optical fiber between the antenna terminal i−1 and the antenna terminal i.
